(19) United States
(12) Patent Application Publication
(10) Pub. No.: US 2001/0030474 A1
(43) Pub. Date: Oct. 18, 2001

(54) Multi-functional vibration actuator capable of suppressing an unstable operation around a resonance frequency

(75) Inventors: Nobuyasu Sakai, Sendai-shi (JP); Fumihiro Suzuki, Shiroishi-shi (JP)

Correspondence Address: FRISHAUF, HOLTZ, GOODMAN &, LANGER & CHICK, PC, 767 THIRD AVENUE, 25TH AVE, NEW YORK, NY, 10017-2023, US

(73) Assignee: TOKIN CORPORATION, Miyagi (JP)

(21) Appl. No.: 09/833,330

(22) Filed: Apr. 12, 2001

(30) Foreign Application Priority Data
Apr. 14, 2000 (JP) 113312/2000

(51) Int. Cl. H02K 7/06; H02K 7/10

(52) U.S. Cl. 310/81

(57) ABSTRACT

In a vibration actuator having a magnetic circuit component (10) and a coil (17) arranged in a gap (14) which is made at one side of the magnetic circuit in a predetermined direction, a space defining member (31, 32, 19) defines an accommodation space (34) to accommodate the magnetic circuit component and the coil. A supporting unit (16,18) supports the magnetic circuit component and the coil so that they are separately movable in the predetermined direction. The space defining member has a sound release hole (33) faced to the other side of the magnetic circuit component in the predetermined direction.

### BACKGROUND OF THE INVENTION

This invention relates to a vibration actuator of a multi-functional type mounted in a mobile communication apparatus, such as a mobile telephone, to generate a ringing tone, a speech sound, and a vibration.

A vibration actuator of the type comprises a magnetic circuit component having a gap on one side in a predetermined direction, a coil arranged in the gap of the magnetic circuit component, a supporting unit supporting the magnetic circuit component and the coil so that the magnetic circuit component and the coil are separately movable in the predetermined direction, and a vibration transmitting portion made of an elastic material such as rubber and fixing the supporting unit. The magnetic circuit component comprises a permanent magnet and a yoke coupled thereto. The supporting unit comprises a leaf spring through which the magnetic circuit component is supported on the vibration transmitting portion, and a vibration member through which the coil is supported on the vibration transmitting portion.

When the coil is supplied with a driving current, the magnetic circuit component or the coil performs a reciprocal movement in the predetermined direction. When the driving current has a low frequency, the vibration transmitting portion serves as a fixed portion. On the other hand, when the driving current has a high frequency, the vibration transmitting portion serves as an elastic body which vibrates as a part of the vibration member. Thus, in each of a vibration mode and a sound mode, the magnetic circuit component and the vibration member are operated under mutual interference to transmit a sound or a vibration to the outside.

However, since the magnetic circuit component is supported simply by the leaf spring, the operation will become unstable around a resonance frequency. This results in generation of a large harmonic distortion component.

### SUMMARY OF THE INVENTION

It is therefore an object of this invention to provide a multi-functional vibration actuator which is capable of suppressing an unstable operation around a resonance frequency to reduce a harmonic distortion component.

It is another object of this invention to provide a multi-functional vibration actuator which is capable of preventing a coil from being released from a vibration member.

Other objects of the present invention will become clear as the description proceeds.

According to an aspect of the present invention, there is provided a vibration actuator comprising a magnetic circuit component having a gap on one side in a predetermined direction, a coil arranged in the gap, a supporting unit supporting the magnetic circuit component and the coil so that the magnetic circuit component and the coil are separately movable in the predetermined direction, and a space defining member defining an accommodation space accommodating the magnetic circuit component and the coil, the space defining member having a sound release hole faced to the other side of the magnetic circuit component in the predetermined direction.

According to another aspect of the present invention, there is provided a vibration actuator comprising a magnetic circuit component having a gap on one side in a predetermined direction, a coil arranged in the gap a supporting unit supporting the magnetic circuit component and the coil so that the magnetic circuit component and the coil are separately movable in the predetermined direction, and a space defining member defining an accommodation space accommodating the magnetic circuit component and the coil, the space defining member having a sound release hole faced to the other side of the magnetic circuit component in the predetermined direction, the magnetic circuit component cooperating with the space defining member to define a damper space arranged between the magnetic circuit component and the cover and communicating with the sound release hole.

According to still another aspect of the present invention, there is provided a vibration actuator comprising a magnetic circuit component having a gap on one side in a predetermined direction, a coil arranged in the gap, a supporting unit supporting the magnetic circuit component and the coil so that the magnetic circuit component and the coil are separately movable in the predetermined direction, and a space defining member defining an accommodation space accommodating the magnetic circuit component and the coil, the space defining member having a sound release hole faced to the other side of the magnetic circuit component in the predetermined direction, the magnetic circuit component cooperating with the space defining member to define a damper space arranged between the magnetic circuit component and the cover and communicating with the sound release hole, the sound release hole having an area corresponding to about 1.3 to 3.5% of an area of the cover.

### BRIEF DESCRIPTION OF THE DRAWING

FIG. 1A is a vertical sectional view of a vibration actuator according to a first embodiment of this invention;

FIG. 1B is a partially-cutaway bottom view of the vibration actuator illustrated in FIG. 1A;

FIG. 2 is a bottom view of a cover used in the vibration actuator illustrated in FIGS. 1A and 1B;

FIG. 3 is a graph showing the relationship between a sound pressure level and a frequency characteristic of the vibration actuator;

FIG. 4 is a vertical sectional view of a vibration actuator according to a second embodiment of this invention;

FIG. 5 is a vertical sectional view of a vibration actuator according to a third embodiment of this invention;

FIG. 6A is a vertical sectional view of a vibration actuator according to a fourth embodiment of this invention; and

FIG. 6B is a partially-cutaway bottom view of the vibration actuator illustrated in FIG. 6A.

### DESCRIPTION OF THE PREFERRED EMBODIMENTS

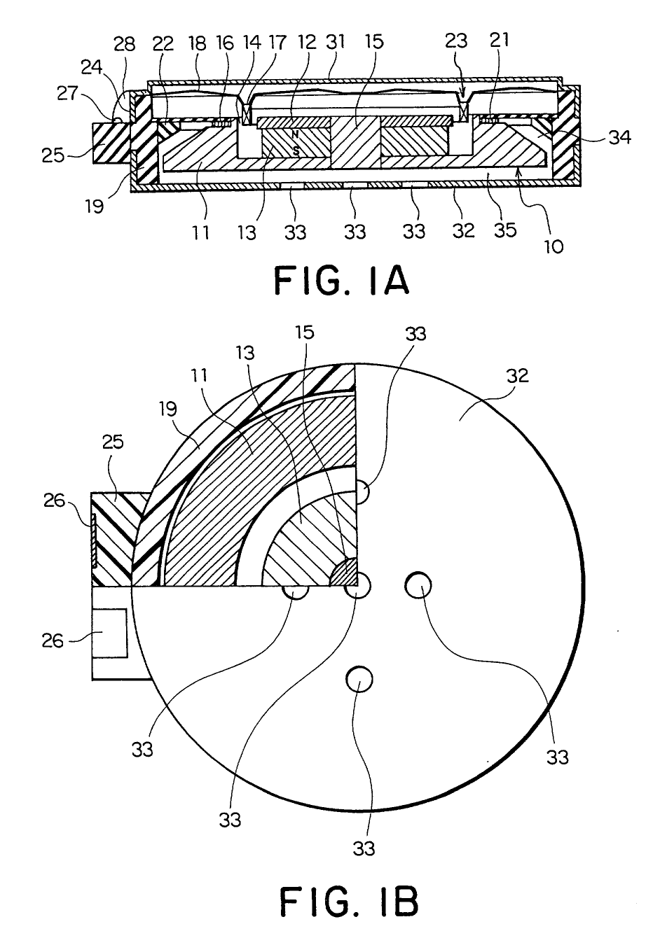

Referring to FIGS. 1A and 1B, description will be made of a vibration actuator according to a first embodiment of this invention.

The vibration actuator has an internal magnet structure and comprises a magnetic circuit component 10 including a yoke 11, a plate 12, and a disk-shaped permanent magnet 13 interposed between the yoke 11 and the plate 12. The vibration actuator further comprises a center shaft 15, a suspension 16 of a plate shape, a coil 17 of a ring shape, a vibration member 18 of a plate shape, a vibration transmitting portion 19 of a ring shape. The center shaft 15 has a bolt-like shape or a pin-like shape and is inserted into a center hole of the magnetic circuit component 10 to coaxially position the yoke 11, the plate 12, and the permanent magnet 13, and is fixed to the yoke 11, the plate 12, and the permanent magnet 13 by caulking or staking. Each of the yoke 11 and the plate 12 is fixed to the permanent magnet 13 under attraction force of the permanent magnet 13, by a combination of the attraction force and an adhesive, or by caulking or staking. The center shaft 15 may be removed after the yoke 11, the plate 12, and the permanent magnet 13 are coaxially positioned. The magnetic circuit component 10 is provided with a gap 14 on one side in a predetermined direction, i.e., on an upper side.

The suspension 16 comprises a ring-shaped plate provided with a plurality of helical leaf springs formed between an inner periphery and an outer periphery thereof. The suspension 16 has an inner peripheral portion fixed to an outer peripheral portion of the yoke 11 by the use of an elastic material 21, such as a tackiness agent, an adhesive, or a resin or by means of caulking or staking. By fixing the suspension 16 to the outer peripheral portion of the yoke 11, the magnetic circuit component 10 is prevented from being shaken. The suspension 16 has an outer peripheral portion fixed to the vibration transmitting portion 19. Thus, the suspension 16 flexibly supports the magnetic circuit component 10 to the vibration transmitting portion 19.

In order to prevent the magnetic circuit component 10 from being brought into contact with the vibration member 18 due to an excessive amplitude of vibration, the vibration transmitting portion 19 is provided with at least stopper 22 formed on its inner peripheral portion. The number of stopper(s) 22 may be any desired number. The stopper 22 may be formed throughout the inner peripheral portion of the vibration transmitting portion 19.

The vibration member 18 has at the lower surface thereof an L-shaped portion 23 shaped in an L shape in section to make two particular surfaces perpendicular to each other. One of the particular surfaces is directed outward in a radial direction of the vibration actuator. An adhesive or the like fixedly attaches the coil 17 to the particular surfaces of the L-shaped portion 23 of the vibration member 18. The coil 17 is disposed in the gap 14 of the magnetic circuit component 10. Since the vibration member 18 with the coil 17 fixedly attached thereto has an L shape, the coil 17 is kept in contact with the vibration member 18 at two surfaces. Thus, the coil 17 is hardly released, as compared with the case where the coil 17 is attached to the vibration member 18 at a single surface.

A coil wire 24 is extracted from the coil 17. The coil wire 24 is adhered to the surface of the vibration member 18 by an adhesive or a tackiness agent so as not to cause an adverse influence upon the vibration of the vibration member 18. Furthermore, the coil wire 24 is connected by a solder 27 to a terminal 26 of a terminal support 25 disposed at an outer peripheral portion of the vibration transmitting portion 19. The coil wire 24 and a connecting portion thereof are covered with a protector 28.

The vibration transmitting portion 19 is formed by an elastic material such as a resin and has a cylindrical shape with an upper opening and a lower opening. The vibration transmitting portion 19 has an upper part and a lower part to which an upper cover 31 and a lower cover 32 are fixed, respectively. The upper cover 31 completely covers the upper opening of the vibration transmitting portion 19. On the other hand, the lower cover 32 covers the lower opening of the vibration transmitting portion 19 but has a plurality of through holes 33 having a relatively small diameter. The through holes 33 collectively serve as a sound release hole or a sound emission hole for releasing or emitting a sound which will be generated by the vibration actuator. Each of the through holes 33 has a circular shape in the illustrated example but may have a shape of an ellipse, an elongated circle, a polygon, or a combination thereof. Alternatively, only a single through hole 33 may be formed. During the operation, the through holes 33 exhibit vibration attenuating function utilizing air viscosity. The upper and the lower covers 31 and 32 cooperate with the vibration transmitting portion 19 to serve as a space defining member defining an accommodation space 34 accommodating the magnetic circuit component 10 and the coil 17 and as a protector for a functional body providing the vibration.

The yoke 11 has a lower part protruding outward to approach an inner peripheral surface of the vibration transmitting portion 19. As a consequence, the yoke 11 cooperates with the lower cover 32 to define a damper space 35 located between the yoke 11 and the lower cover 32 and communicating with the through holes 33. As will later be described in conjunction with a specific example, the total area of the sound release holes is selected to fall within a range between about 1.3% and about 3.5% of the bottom area of the lower cover 32.

The vibration member 18 has a flat shape, a saucer shape, a curved shape, a corrugated shape, or a combination thereof. If the vibration member 18 has a curved shape, a single radius of curvature or a combination of different radii of curvature is appropriately selected to achieve a predetermined sound characteristic. By increasing the rigidity of the vibration member 18 within the coil 17, a harmonic distortion in a high-frequency region can be reduced.

The vibration member 18 is made of polyether imide (PEI). Alternatively, the vibration member 5 may be made of another plastic film material such as polyethylene terephthalate (PET), polycarbonate (PC), polyphenylenesulfide (PPS), polyarylate (PAR), polyimide (PI), and aramide (PPTA, poly-(paraphenylene terephthalamide)).

In order to assure a wider amplitude of the vibration member 18, an outer peripheral portion of the vibration member 18 is fixed to the vibration transmitting portion 19 through an elastic material such as a tackiness agent, an adhesive, or a resin.

When the coil 17 is supplied with a driving current, the magnetic circuit component 10 flexibly supported by the vibration member 18 and the suspension 16 vibrates. At this time, the vibration transmitting portion 19 serves as a fixed portion at a low frequency and, on the other hand, serves as an elastic body at a high frequency to vibrate as a part of the vibration member 18. Thus, in each of a vibration mode and a sound mode, the magnetic circuit member 10 and the vibration member are operated under mutual interference. Herein, the through holes 33 exhibit a vibration attenuation function utilizing air viscosity.

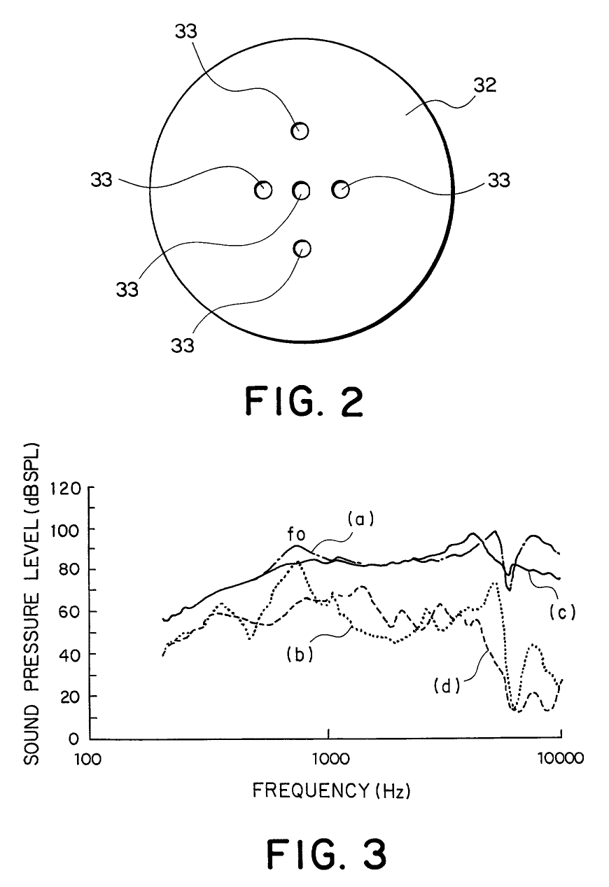

Referring to FIG. 2, description will be made of the lower cover 32.

The lower cover 32 has an outer diameter of 17 mm and a plurality of through holes 33, five in number, formed at desired positions of the bottom surface to serve as sound release holes. The total area of the sound release holes falls within a range between about 3 and about 8 mm². The number of the through holes 32 may be four or less or six or more. The vibration actuator as a whole has an outer dimension including the outer diameter of 17 mm substantially equal to that of the lower cover 32 and the thickness (the length in the vertical direction) of 4 mm.

Referring to FIG. 3, description will be made of the relationship between a sound pressure level and a frequency characteristic, i.e., a sound characteristic of the vibration actuator.

In the FIG. 3, a dash-and-dot line (a) and a dotted line (b) represent a fundamental wave and a harmonic distortion in case where the lower cover 32 is not used. In case where the lower cover 32 is not used, a desired sound pressure level is satisfied. However, the harmonic distortion of a large magnitude is produced due to an unstable nonlinear operation of the vibration member 18 around a resonance frequency (f₀).

A thick solid line (c) and a thick dotted line (d) represent a fundamental wave and a harmonic distortion in case where the lower cover 32 in FIG. 2 is used. In case where the lower cover 32 is used, it is possible to suppress the unstable nonlinear operation of the vibration member 18 around the resonance frequency (f₀) so as to reduce the harmonic distortion component. In addition, it is possible to flatten the characteristic in a low frequency region.

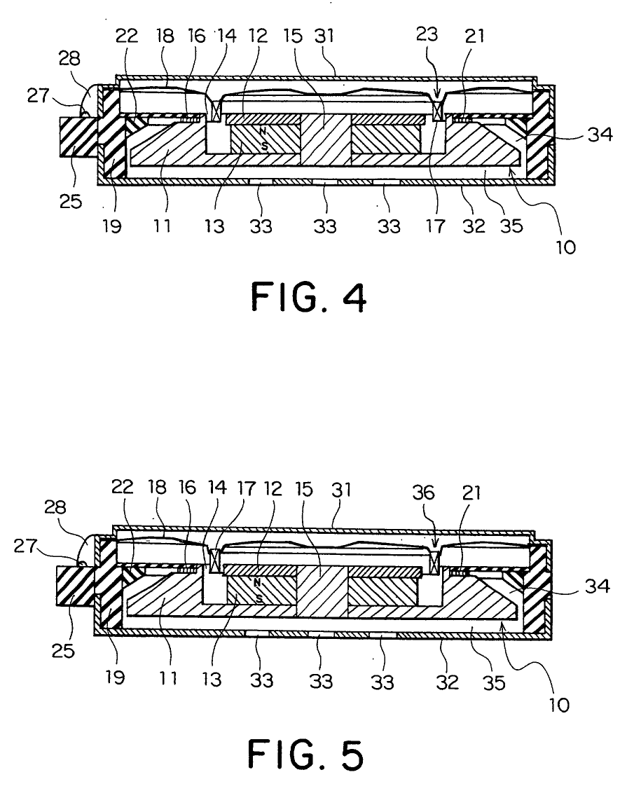

Referring to FIG. 4, description will be made of a vibration actuator according to a second embodiment of this invention. Similar parts are designated by like reference numerals and will not be described any longer.

The vibration actuator of FIG. 4 is different from that of FIGS. 1A and 1B in that the L-shaped portion 23 of the vibration member 18 in FIG. 1A is replaced by an L-shaped portion 35. The L-shaped portion 23 is shaped in an L shape in section to make two particular surfaces perpendicular to each other. The particular surfaces are directed inward in the radial direction of the vibration actuator. An adhesive or the like fixedly attaches the coil 17 to the particular surfaces of the L-shaped portion 23 of the vibration member 18.

Referring to FIG. 5, description will be made of a vibration actuator according to a third embodiment of this invention. Similar parts are designated by like reference numerals and will not be described any longer.

The vibration actuator of FIG. 5 is different from that of FIGS. 1A and 1B in that the L-shaped portion 23 of the vibration member 5 in FIG. 1A is replaced by a U-shaped portion 36. With this structure, the coil 17 is fitted in the U-shaped portion 36 and kept in contact with the vibration member 18 at three surfaces. Therefore, the coil 17 is hardly released from the vibration member 18 as compared with the L shape illustrated in FIGS. 1A or 4 and providing two surfaces as contact surfaces. Thus, this structure is highly reliable.

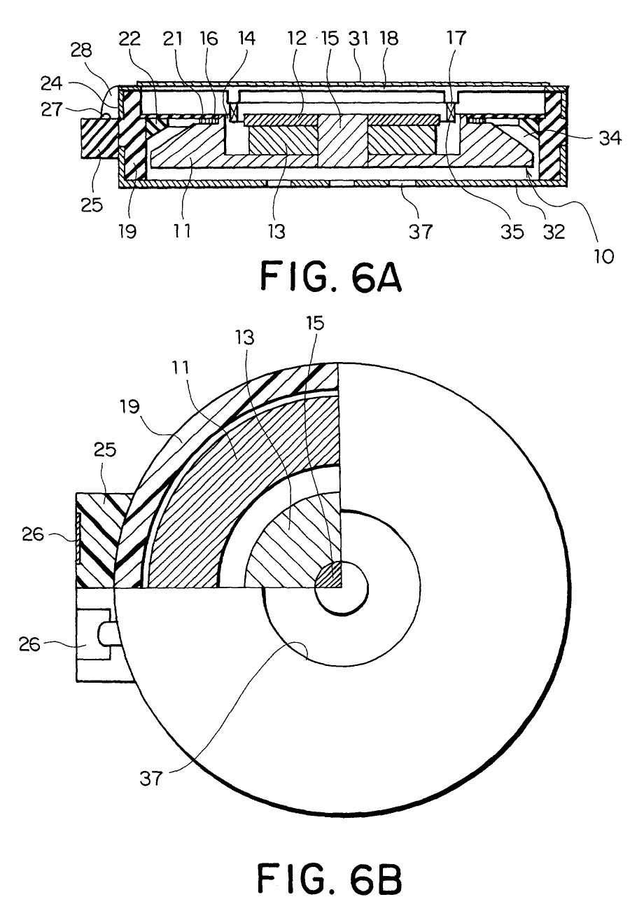

Referring to FIGS. 6A and 6B, description will be made of a vibration actuator according to a third embodiment of this invention. Similar parts are designated by like reference numerals and will not be described any longer.

In the vibration actuator of FIGS. 6A and 6B, the lower cover 32 is provided with a single through hole 37 having a relatively large diameter. The through hole 37 is faced to the magnetic circuit component 10 and serves as a sound release hole.

While the present invention has thus far been described in connection with a few embodiments thereof, it will readily be possible for those skilled in the art to put this invention into practice in various other manners. For example, instead of the inner magnet structure mentioned above, the magnetic circuit component 10 may have an external magnet structure well known in the art. In the magnetic circuit component 10, an end portion of the yoke may have an uneven or non-flat shape having a protrusion or a recess in order to facilitate generation of a high magnetic flux density. A magnetic pole of the permanent magnet 13 may be oriented in any direction. The suspension 16 may be integrally formed with the vibration transmitting portion by insert molding, welding, adhesion, or the like.

What is claimed is:

1. A vibration actuator comprising:
a magnetic circuit component having a gap on one side in a predetermined direction;
a coil arranged in said gap;
a supporting unit supporting said magnetic circuit component and said coil so that said magnetic circuit component and said coil are separately movable in said predetermined direction; and
a space defining member defining an accommodation space accommodating said magnetic circuit component and said coil, said space defining member having a sound release hole faced to the other side of said magnetic circuit component in said predetermined direction.

2. A vibration actuator as claimed in claim 1, wherein said sound release hole is formed by at least one through hole.

3. A vibration actuator as claimed in claim 2, wherein said at least one through hole has a shape of one selected from a circle, an ellipse, an elongated circle, a polygon, and a combination thereof.

4. A vibration actuator as claimed in claim 1, wherein said space defining member has a cover faced to the other side of said magnetic circuit component in said predetermined direction, said sound release hole being formed in said cover so that air damping effect is exhibited between said yoke and said cover.

5. A vibration actuator comprising:
a magnetic circuit component having a gap on one side in a predetermined direction;
a coil arranged in said gap;
a supporting unit supporting said magnetic circuit component and said coil so that said magnetic circuit component and said coil are separately movable in said predetermined direction; and
a space defining member defining an accommodation space accommodating said magnetic circuit component and said coil, said space defining member having a sound release hole faced to the other side of said magnetic circuit component in said predetermined direction, said magnetic circuit component cooperating with said space defining member to define a damper space arranged between said magnetic circuit component and said cover and communicating with said sound release hole.

6. A vibration actuator comprising:
a magnetic circuit component having a gap on one side in a predetermined direction;
a coil arranged in said gap;
a supporting unit supporting said magnetic circuit component and said coil so that said magnetic circuit component and said coil are separately movable in said predetermined direction; and
a space defining member defining an accommodation space accommodating said magnetic circuit component and said coil, said space defining member having a sound release hole faced to the other side of said magnetic circuit component in said predetermined direction, said magnetic circuit component cooperating with said space defining member to define a damper space arranged between said magnetic circuit component and said cover and communicating with said sound release hole, said sound release hole having an area corresponding to about 1.3 to 3.5% of an area of said cover.

7. A vibration actuator as claimed in claim 1, wherein said space defining member has a vibration transmitting portion to which said supporting unit is fixed.

8. A vibration actuator as claimed in claim 7, wherein said supporting unit comprises a helical leaf spring through which said magnetic circuit component is supported on said vibration transmitting portion.

9. A vibration actuator as claimed in claim 7, wherein said supporting unit comprises a vibration member through which said coil is supported on said vibration transmitting portion.

10. A vibration actuator as claimed in claim 9, wherein said vibration member has a flat shape, a saucer shape, a curved shape, a corrugated shape, or a combination thereof.

11. A vibration actuator as claimed in claim 9, wherein said vibration member is made of at least one kind of plastic film material selected from polyether imide, polyethylene terephthalate, polycarbonate, polyphenylenesulfide, polyarylate, polyimide, and aramide.

12. A vibration actuator as claimed in claim 9, wherein said vibration member is faced to a plurality of surfaces of said coil and adhered to these surfaces by an adhesive.

13. A vibration actuator as claimed in claim 1, wherein said sound release hole serves to exhibit vibration attenuating function utilizing air viscosity.
